(19) United States
(12) Patent Application Publication
(10) Pub. No.: US 2003/0125870 A1
(43) Pub. Date: Jul. 3, 2003

(54) System and method for navigating a means of transportation

(76) Inventors: Stefan Woestemeyer, Hildesheim (DE); Ulrich Gaertner, Nordstemmen (DE)

Correspondence Address: KENYON & KENYON, ONE BROADWAY, NEW YORK, NY, 10004, US

(21) Appl. No.: 10/190,780

(22) Filed: Jul. 8, 2002

(30) Foreign Application Priority Data
Jul. 6, 2001 (DE) 101 32 887.7

(51) Int. Cl. G01C 21/26

(52) U.S. Cl. 701/200

(57) ABSTRACT

A system and a method are provided for navigating an arrangement of transportation, for example, a vehicle, an aircraft, a motor vehicle, or a ship, from at least one location to at least one destination, which minimize the demand on memory capacity required for voice recognition and conversion, the voice data entry being compared with subsets, for example, with sequential segments or with successive subsets of the navigation database elements stored in the memory unit.

### FIELD OF THE INVENTION

The present invention relates to a system for navigating an arrangement for transportation, for example, a vehicle, an aircraft, a motor vehicle, or a ship, from at least one location to at least one destination, having at least one input device for entering at least one command, at least one location, and/or at least one destination, the input device having at least one assigned voice data entry module operable to recognize at least one voice data entry and to convert the voice data entry into at least one corresponding input to the system. The voice data entry module includes at least one memory unit for elements of at least one navigation database, for example, for command names, place names, street names and/or Points of Interest (POI). At least one element of the navigation database is assigned to the voice data entry by a comparison performed by at least one comparator arrangement. The respective assigned element is routed to the system as a command, a location, and/or a destination.

The present invention also relates to a method for navigating an arrangement for transportation, for example, a vehicle, an aircraft, a motor vehicle, or a ship, from at least one location to at least one destination, at least one command, at least one location, and/or at least one destination being entered using at least one input device, a voice recognition being performed in the input device via at least one voice data entry module, at least one voice data entry being converted into a corresponding entry into the system, elements of at least one navigation database, for example, command names, place names, street names and/or Points of Interest (POI), being available in at least one memory unit, the voice data entry being assigned at least one element of the navigation database using at least one comparator arrangement, and the assigned element being routed to the system as a command, location, and/or destination.

### BACKGROUND INFORMATION

Navigation systems installed in arrangements for transportation, such as vehicles, aircraft, motor vehicles, or ships, may quickly and safely guide the operator of the arrangement for transportation to a desired destination, without the operator having to first spend time and effort to plan a route and acquire respective maps.

For this purpose, it is believed that suitable navigation systems, for example, charts, maps or street maps, are available on stored CD-ROMs (Compact Disc-Read Only Memory) or DVDs (Digital Versatile Disc), etc. The navigation system may use GPS (Global Positioning System), for example, to determine a current location and to calculate respective navigation instructions to a predetermined destination. In this context, the navigation data may contain, for example, data concerning roads and paths for motor vehicles.

However, before the navigation system may calculate a route from a present location to a destination, it is believed that the user must enter the desired destination and, if necessary, also enter the present location, for example, via a keyboard, or a similar, manually-activated input device. This may be both complicated and time-consuming, and may require knowledge of how to operate a navigation system.

For this reason, at least some navigation systems include a voice activation system, as referred to, for example, in German Published Patent Application No. 198 35 556. The voice activation system may be an external component connected to the navigation system via a (data) bus or may be a unit integrated into the navigation system. To use voice-activated navigation, for example, to enter place, street names, and/or Points of Interest, the navigation database may need to be aligned via spelling out, for example.

This may permit a list of the most-probable names (i.e., a result list) to be compiled and compared with the voice-entered letter sequence from the letter hypotheses. The complete list of elements may be required from the navigation database for this comparison, which may be both memory-intensive and time consuming.

### SUMMARY OF THE INVENTION

An object of the present invention is to provide a system and method for navigating an arrangement for transportation, for example, a vehicle, an aircraft, a motor vehicle, or a ship, from at least one location to at least one destination, whereby the demand on memory capacity, for example, the demand on a main memory capacity, is minimized.

According to an exemplary embodiment of the present invention, an efficient system and a comfortable and easy-to-implement method are provided, whereby a partial matching, i.e., a comparison of the voice data entry with the elements of the navigation database, is performed using successive segments or segments from the navigation database. In this manner, the required memory capacity may be reduced.

For this purpose, portions of the navigation database are sequentially read from the navigation data carrier, such as a CD-ROM or a DVD, whereby processing in the system, for example, processing in a central processor unit (CPU) of the system, may occupy less memory compared to other navigation technology, despite involving multiple calculations.

Alternatively, or in addition, the recognized voice data entry may be transferred to the system via at least one CAN-Bus (Controller Area Network), via at least one other electric bus, or via at least one optical interface, such as at least one optical waveguide (LW). For this purpose, the voice data entry module may be connected to the system via such a bus. Since a CAN-Bus, for example, may be available in various navigation systems, these systems, which may already be in operation, may be simply, quickly, and cost-effectively retrofitted with voice data entry capabilities.

### BRIEF DESCRIPTION OF THE DRAWINGS

FIG. 1 is a block diagram of an exemplary system according to the present invention.

FIG. 2 is a flow diagram of an exemplary method according to the present invention.

### DETAILED DESCRIPTION

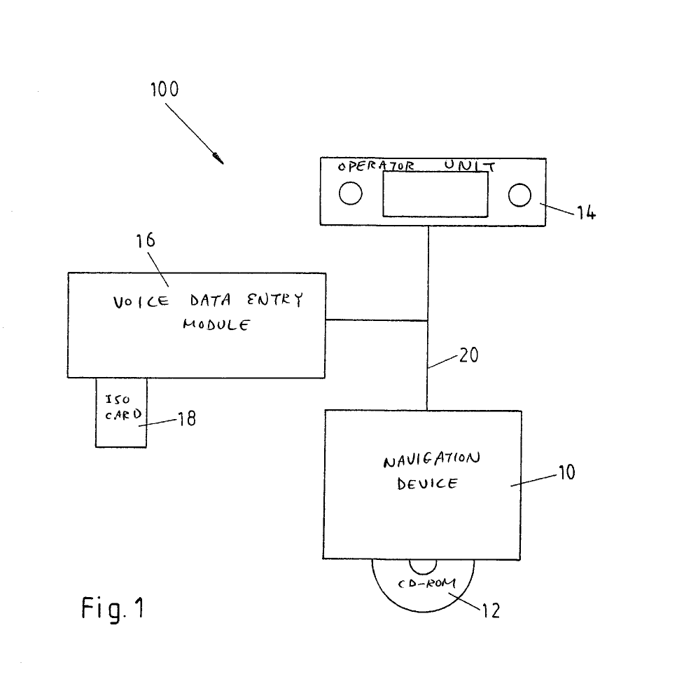

The exemplary system 100 according to the present invention described with reference to FIG. 1 includes a navigation device 10 having a reader for a CD-ROM 12 or for a DVD, an operator unit 14 for the manual input of commands, place or street names, and/or Points of Interest (POI), and a voice data entry module 16 having a card reader for a PCMCIA, ISO-card 18, or for a different data carrier. Navigation device 10, operator unit 14, and voice data entry module 16 are interconnected via a control bus 20.

Card 18 provides commands, place or street names, and/or Points of Interest to the voice data entry module 16, all of which are assigned to a voice data entry. After completing the assignment, the respective command, place or street name, and/or the respective Point of Interest (POI) is transferred to navigation device 10. This navigation device 10 executes the command or establishes the place or street name or the Point of Interest (POI) transmitted by voice data entry module 16 as the current location or destination.

Voice data entry module 16 performs voice recognition, for example, by comparing recognized letter sequences, syllables or words with stored names for commands, place or street names, and/or Points of Interest (POI). These names could be alternatively transmitted from CD-ROM 12 or from a DVD in navigation device 10 via control bus 20 for the comparison process. By storing the names on card 18, a faster voice recognition may be achieved, since voice data entry module 16 may directly read the names.

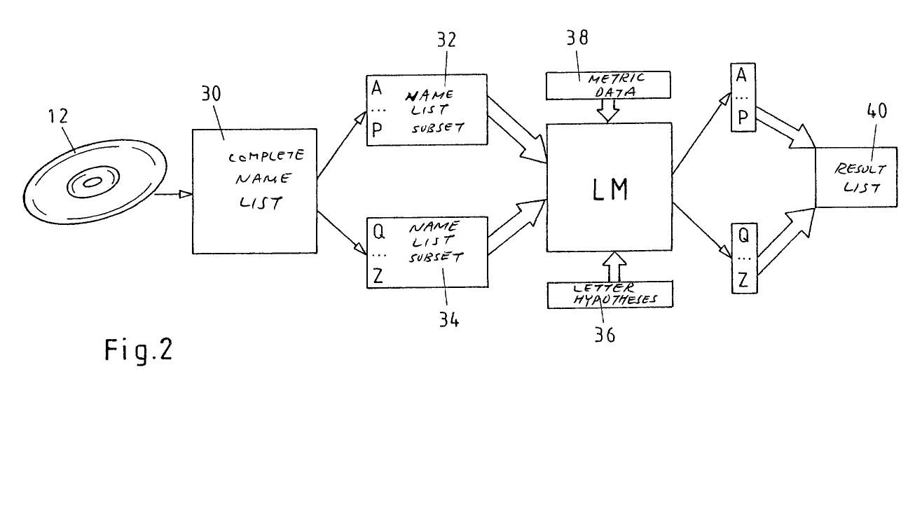

In an exemplary embodiment according to the present invention, while the “matching” or comparing process described above is being performed based on complete name list 30, as shown in FIG. 2, several, e.g., at least two, separate steps are provided for this purpose, since the voice data entry is compared with subsets 32 or 34 (compressed name lists from “A” to “P” or from “Q” to “Z”, corresponding to subsets 32 or 34->partial processing) of the navigation database elements stored on CD-ROM 12 or on a DVD. It should be noted that more than two subsets may be provided, i.e., more than two name lists corresponding to the two subsets may be provided.

As shown in FIG. 2, successive segments of the navigation data carrier may be accessed multiple times (at least twice) for the comparison of letter hypotheses 36 with the possible destinations, considering metric data 38. Thus, by partial “matching,” the navigation data carrier may be accessed multiple times in a burst-like fashion, while using little volatile memory of the central processor unit of the system 100.

The results of the respective partial comparisons (partial “distance”-list according to FIG. 2) are temporarily stored until the final evaluation. As shown in FIG. 2, the final result of this evaluation is a result list 40 containing the most probable destinations.

What is claimed is:

1. A system for navigating an arrangement for transportation from at least one location to at least one destination, the system comprising:
at least one input device for entering at least one of the following:
a) a command,
b) the at least one location, and
c) the at least one destination; and
at least one voice data entry module assigned to the input device, the voice data entry module operable to recognize at least one voice data entry and convert the voice data entry into at least one corresponding system entry, the voice data entry module including:
a) at least one memory unit for storing elements of at least one navigation database,
b) a comparator for assigning at least one of the elements of the navigation database to the voice data entry in accordance with a comparison of the voice data entry with subsets, and
c) a routing arrangement for routing the assigned element to the system as at least one of a command, a location, and a destination.

2. The system according to claim 1, wherein the arrangement for transportation includes one of a vehicle, an aircraft, a motor vehicle, and a ship.

3. The system according to claim 1, wherein the elements of the at least one navigation database include at least one of command names, place names, street names, and points of interest.

4. The system according to claim 1, wherein the subsets include one of sequential segments and successive subsets of the elements stored in the memory unit.

5. The system according to claim 3, wherein the command names, the place names, the street names, and the points of interest are stored in the subsets according to one of the following:
a) at least one pattern of order, and
b) an assigned probability.

6. The system according to claim 5, wherein the at least one pattern of order includes an alphabetic pattern of order.

7. The system according to claim 1, wherein the voice data entry module is one of:
a) integrated into the system, and
b) located outside of the system and linked to the system.

8. The system according to claim 7, wherein the voice data entry module is connected to the system in one of the following ways:
a) via at least one data bus,
b) via at least one other electrical bus, and
c) via at least one optical interface.

9. The system according to claim 8, wherein the at least one data bus includes a Controller Area Network and the at least one optical interface includes at least one optical waveguide.

10. The system according to claim 1, wherein the memory unit includes at least one of a Compact Disc and a Digital Versatile Disc, and wherein the voice data entry module includes at least one of a Compact-Disc reading device and a Digital-Versatile-Disc reading device.

11. The system according to claim 1, wherein the memory unit includes at least one of a card unit and one other memory unit, and wherein the voice data entry module includes at least one of a data input unit and a card reading device.

12. The system according to claim 11, wherein the at least one card unit includes at least one of a PCMCIA-card and an ISO card.

13. A method for navigating an arrangement for transportation from at least one location to at least one destination, the method comprising the steps of:
entering, using at least one input device, at least one of the following:
a) a command,
b) the at least one location, and
c) the at least one destination;
performing a voice recognition via at least one voice data entry module in the input device, wherein at least one voice data entry is converted to at least one corresponding system input;
making elements of at least one navigation database available in at least one memory unit;
assigning at least one of the elements of the navigation database to the voice data entry in accordance with a comparison of the voice data entry with subsets, the comparison being performed by a comparator; and
routing the assigned element to the system as at least one of a command, a location, and a destination.

14. The method according to claim 13, wherein the arrangement for transportation includes one of a vehicle, an aircraft, a motor vehicle and a ship.

15. The method according to claim 13, wherein the elements of the at least one navigation database include at least one of command names, place names, street names, and points of interest.

16. The method according to claim 13, wherein the subsets include one of sequential segments and successive subsets of the elements stored in the memory unit.

17. The method according to claim 13, wherein results of respective comparisons are temporarily stored until a final evaluation.

18. The method according to claim 15, wherein the command names, the place names, the street names, and the points of interest are stored in the subsets according to one of the following:
a) at least one pattern of order, and
b) an assigned probability.

19. The method according to claim 18, wherein the at least one pattern of order includes an alphabetic pattern of order.

20. The method according to claim 13, wherein a recognized voice data entry is transmitted to the system in one of the following ways:
a) via at least one data bus,
b) via at least one other electrical bus, and
c) via at least one optical interface.

21. The method according to claim 20, wherein the at least one data bus includes a Controller Area Network and the at least one optical interface includes at least one optical waveguide.

22. The method according to claim 13, wherein the elements of the navigation database are stored on at least one of a Compact Disc and a Digital Versatile Disc.

23. The method according to claim 13, wherein the elements of the navigation database are stored in the input device on at least one of a PCMCIA-card, an ISO card, and one other memory unit.
